(19) United States
(12) Patent Application Publication
(10) Pub. No.: US 2007/0071842 A1
(43) Pub. Date: Mar. 29, 2007

(54) Apparatus for producing fibers

(75) Inventors: Jan-Min Lin, Benchiao City (TW); Chao-Chun Peng, Hsinchu City (TW); Tzu-Shiang Huang, Taipei City (TW); Ting-Chih Chen, Tu-Chen City (TW)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Taiwan Textile Research Institute, Tu-Chen City (TW)

(21) Appl. No.: 11/323,730

(22) Filed: Dec. 20, 2005

(30) Foreign Application Priority Data
Sep. 27, 2005 (TW) 94133591

(51) Int. Cl. B29C 47/34

(52) U.S. Cl. 425/66

(57) ABSTRACT

An apparatus for producing fibers includes a raw materials supplier, a coagulating agents supplier and at least one spray nozzle. The raw materials supplier is used for supplying raw materials. The coagulating agents supplier is used for supplying coagulating agents. The spray nozzle has an inner needle and an outer needle. The inner needle is connected to the raw materials supplier for spraying the raw materials. The outer needle is connected to the coagulating agents supplier and covers the inner needle for spraying the coagulating agents. The raw materials sprayed by the inner needle interact with the coagulating agents sprayed by the outer needle to form the fibers.

### RELATED APPLICATIONS

The present application is based on, and claims priority from, Taiwan Application Ser. No. 94133591, filed Sep. 27, 2005, the disclosure of which is hereby incorporated by reference herein in its entirety.

### BACKGROUND

1. Field of Invention

The present invention relates to an apparatus for producing fibers. More particularly, the present invention relates to an apparatus for producing fibers by wet spinning.

2. Description of Related Art

Manufacturing technology of nonwoven fabrics has improved and, with advances in technologies borrowed from the paper-making industry, has been applied to the textile industry in recent years. Nonwoven fabrics are continuously developed due to their advantages of low manufacturing cost and time.

Nonwoven fabrics are defined as a kind of fabric consisting of a plurality of different fibers adhered to each other by a chemical adhesive rather than being woven or knitted together. The fibers may be animal fibers, chemical fibers or metal fibers.

Spinning is the first step of a nonwoven fabric manufacturing method. The spinning step may produce a mass of fibers. Then, the fibers are combed by a card to form thin nets. After the thin nets are formed, they are laid on each other to form a thick net. After the thick net is formed, the thick net is drafted by a draft device to adjust the stress of the thick net. Then, the fibers in the thick net are adhered to each other. The subsequent steps may comprise enhancing the aesthetic effect of the nonwoven fabrics or modifying the chemical or physical characteristics of the nonwoven fabrics. There are two kinds of spinning steps applied to manufacture nonwoven fabrics, of which manufacturers should select one depending on raw materials.

One is dry spinning. The first step of the dry spinning is dissolving copolymer in a solvent to form raw materials. Then, a spray nozzle sprays the raw materials. After the raw materials are sprayed, the raw materials are coagulated by hot gas to form fibers. However, the fibers may not be coagulated fully if hot gas has not sufficiently affected them and the fibers get entangled with each other. Moreover, if the hot gas has blown obliquely, the strength of the fibers may be so weak that the fibers cannot be thinned down sufficiently in the subsequent steps.

The other step is wet spinning. A difference between wet and dry spinning is in the coagulating step. In wet spinning, the raw materials are sprayed in coagulating agents for coagulating the raw materials to form the fibers.

The fibers made by either wet or dry spinning need additional steps to form fibers. First, the fibers are extended and thinned down. Then, in a thermal treatment process, the fibers are blown by gas to vaporize the solvent that dissolves the copolymer. After the thermal treatment process, the fibers are cut and twisted to form the fibers.

For the forgoing reasons, there is a need for an apparatus for producing fibers that can decrease the number of steps for manufacturing nonwoven fabrics to reduce the cost of the nonwoven fabrics.

### SUMMARY

It is therefore an aspect of the present invention to provide an apparatus for producing fibers that can adjust the diameter of the fibers such that an extending step is not necessary to thin down the fibers.

It is another aspect of the present invention to provide an apparatus for producing fibers that can adjust a distance between the top of an inner needle and the top of an outer needle to be adapted for different kinds of raw materials.

It is still another aspect of the present invention to provide an apparatus for producing fibers that can coagulate and extend the fibers in one step such that the number of steps for manufacturing nonwoven fabrics is decreased.

It is yet another aspect of the present invention to provide an apparatus for producing fibers that can produce different diameter fibers simultaneously.

In accordance with the foregoing and other aspects of the present invention, an apparatus for producing fibers is provided that includes a raw materials supplier, a coagulating agents supplier, and at least one spray nozzle. The raw materials supplier is used for supplying raw materials. The coagulating agents supplier is used for supplying coagulating agents. The spray nozzle has an inner needle and an outer needle. The inner needle is connected to the raw materials supplier for spraying the raw materials. The outer needle is connected to the coagulating agents supplier and covers the inner needle for spraying the coagulating agents. The raw materials sprayed by the inner needle interact with the coagulating agents sprayed by the outer needle to form the fibers.

According to one embodiment of the invention, the internal diameter of the outer needle is substantially between 0.05 mm to 1 mm. The internal diameter of the inner needle is substantially between 0.05 mm to 1 mm. However, the internal diameter of the outer needle needs to be larger than the external diameter of the inner needle. Moreover, the internal diameter of the inner needle and the internal diameter of the outer needle depend on the diameter of the fibers required.

The coagulating agents sprayed by the outer needle may be vaporous. Moreover, the coagulating agents are pressed out of the outer needle. The pressure at which the coagulating agents are pressed depends on different requirements. For example, high pressure results in thinner fibers.

A distance between the top of the inner needle and the top of the outer needle is adjustable to be adapted for different kinds of raw materials. For example, the top of the inner needle may be higher or lower than the top of the outer needle.

Furthermore, there may be a heating needle covering the outer needle. The heating needle is used for spraying hot gas to enhance coagulating the fibers.

In conclusion, the apparatus for producing fibers according to the embodiments of the invention is able to adjust the diameter of the fibers to satisfy different requirements such that an extending step is not necessary to thin down the fibers. Moreover, the apparatus for producing fibers according to the embodiments of the invention is able to adjust the coagulating level to satisfy different requirements such that the amount of chemical adhesives can be reduced if the coagulating level is low, or the fibers can be strengthened and prevented from getting entangled with each other if the coagulating level is high. In addition, the distance between the top of the inner needle and the top of the outer needle is adjustable such that the apparatus for producing fibers according to the embodiments of the invention is able to be adapted for different kinds of raw materials.

It is to be understood that both the foregoing general description and the following detailed description are by examples and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 is a drawing showing an apparatus for producing fibers according to one preferred embodiment of this invention;

FIG. 2 is a drawing showing the arrangement of spray nozzles in the apparatus according to one preferred embodiment of this invention;

FIGS. 3A and 3B are drawings showing the spray nozzles according to preferred embodiments of this invention; and

FIG. 4 is a drawing showing a heating needle according to preferred embodiments of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

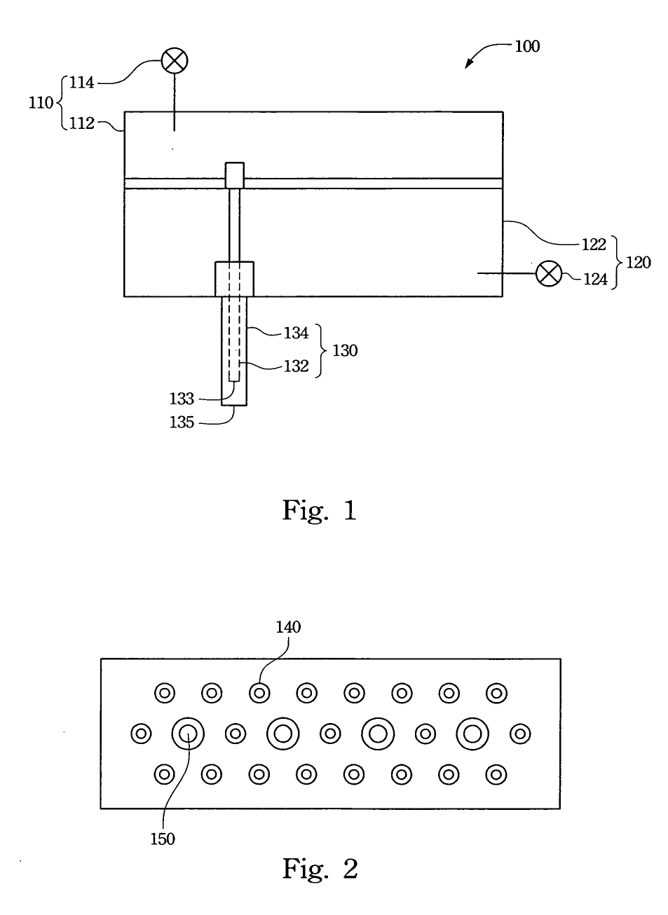

Reference is made to FIG. 1, which is a drawing showing an apparatus for producing fibers according to one preferred embodiment of this invention in FIG. 1, an apparatus 100 for producing fibers includes a raw materials supplier 110, a coagulating agents supplier 120 and at least one spray nozzle 130. The raw materials supplier 110 is used for supplying raw materials. The coagulating agents supplier 120 is used for supplying coagulating agents. The spray nozzle 130 has an inner needle 132 and an outer needle 134. The inner needle 132 is connected to the raw materials supplier 110 for spraying the raw materials. The outer needle 134 is connected to the coagulating agents supplier 120 and covers the inner needle 132 for spraying the coagulating agents. The raw materials sprayed by the inner needle 132 interact with the coagulating agents sprayed by the outer needle 134 to form the fibers.

The raw materials supplier 110 in FIG. 1 includes a raw materials pump 114 and a raw materials tank 112 connected to the raw materials pump 114. Similarly, the coagulating agents supplier 120 in FIG. 1 includes a coagulating agents pump 124 and a coagulating agents tank 122 connected to the coagulating agents pump 124. However, the raw materials supplier and the coagulating agents supplier may also be a combination of pipes and valves or other fluid machinery.

According to one embodiment of the invention, the internal diameter of the outer needle 134 is substantially between 0.05 mm to 1 mm. The internal diameter of the inner needle 132 is substantially between 0.05 mm to 1 mm. However, the internal diameter of the outer needle 134 needs to be larger than the external diameter of the inner needle 132. Moreover, the internal diameter of the inner needle 132 and the internal diameter of the outer needle 134 depend on the diameter of the fibers required.

Although there is only one spray nozzle shown in FIG. 1, there may also be more than one spray nozzle mounted in the apparatus according to another embodiment of the invention. Moreover, the spray nozzles mounted in the apparatus may have different diameters. In addition, the spray nozzles may also be replaceable.

Reference is made to FIG. 2, which is a drawing showing an arrangement of the spray nozzles in the apparatus. In FIG. 2, the apparatus may include three rows of twenty-five spray nozzles. There are small spray nozzles 140 mounted in the first row, small spray nozzles 140 and large spray nozzles 150 mounted at intervals in the second row, and small spray nozzles 140 mounted in the third row, wherein the diameter of the large spray nozzles 150 is larger than the diameter of the small spray nozzles 140. However, other arrangements may also be applied to this invention.

Reference is made to FIG. 1. The coagulating agents sprayed by the outer needle 134 may be vaporous or liquid. Moreover, the coagulating agents are pressed out of the outer needle 134. The pressure at which the coagulating agents are pressed depends on different requirements. For example, high pressure results in thinner fibers produced. In addition, the flow rate and velocity of the coagulating agents can be adjustable for satisfying different requirements, such as the coagulating level of the fibers.

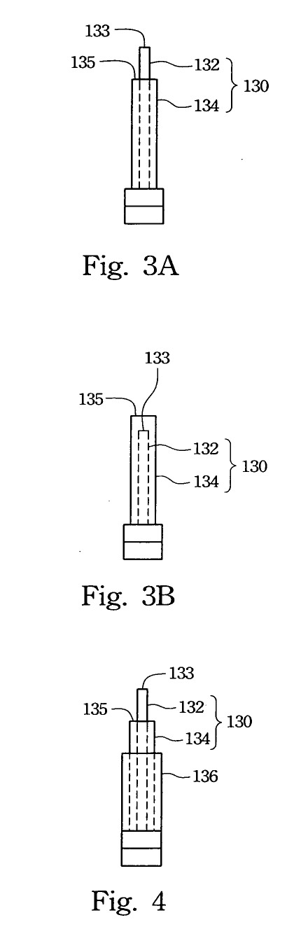

Reference is made to FIGS. 3A and 3B, which are drawings showing the spray nozzles according to preferred embodiments of this invention. A distance between the top 133 of the inner needle 132 and the top 135 of the outer needle 134 is adjustable to be adapted for different kinds of raw materials. For example, the top 133 of the inner needle 132 may be higher than the top 135 of the outer needle 134 (as shown in FIG. 3A). Alternatively, the top 133 of the inner needle 132 may be lower than the top 135 of the outer needle 134 (as shown in FIG. 3B).

Reference is made to FIG. 4, which is a drawing showing a heating needle according to preferred embodiments of this invention. There may be a heating Is needle 136 covering the outer needle 134. The heating needle 136 is used for spraying hot gas to enhance coagulating the fibers.

In conclusion, the apparatus for producing fibers according to the embodiments of the invention has the advantages of:

(1) having the ability to adjust the diameter of the fibers to satisfy different requirements such that an extending step is not necessary to thin down the fibers;

(2) having the ability to adjust the distance between the top of the inner needle and the top of the outer needle such that the apparatus for producing fibers according to the embodiments of the invention is able to be adapted for different kinds of raw materials;

(3) having the ability to produce thick fibers and thin fibers simultaneously, wherein the thick fibers can build up nonwoven fabric strength; and

(4) having the ability to adjust the coagulating level to satisfy different requirements such that the amount of chemical adhesives can be reduced if the coagulating level is low, or the fibers can be strengthened and prevented from getting entangled with each other if the coagulating level is high.

It will be apparent to those skilled in the art that various modifications and variations can be made to the structure of the present invention without departing from the scope or spirit of the invention. In view of the foregoing, it is intended that the present invention cover modifications and variations of this invention. provided they fall within the scope of the following claims and their equivalents.

What is claimed is:

1. An apparatus for producing fibers, comprising:
a raw materials supplier for supplying raw materials;
a coagulating agents supplier for supplying coagulating agents; and
at least one spray nozzle comprising:
an inner needle connected to the raw materials supplier for spraying the raw materials; and
an outer needle connected to the coagulating agents supplier and covering the inner needle for spraying the coagulating agents, whereby the raw materials sprayed by the inner needle interact with the coagulating agents sprayed by the outer needle to form the fibers.

2. The apparatus of claim 1, wherein the outer needle has an internal diameter substantially between 0.05 mm to 1 mm.

3. The apparatus of claim 1, wherein the inner needle has an internal diameter substantially between 0.05 mm to 1 mm.

4. The apparatus of claim 1, wherein the coagulating agents sprayed by the outer needle are vaporous.

5. The apparatus of claim 4, wherein the coagulating agents sprayed by the outer needle are pressed out of the outer needle.

6. The apparatus of claim 1, wherein the spray nozzle is replaceable.

7. The apparatus of claim 1, wherein the spray nozzle has a distance between the top of the inner needle and the top of the outer needle, and the distance is adjustable.

8. The apparatus of claim 1, wherein when the number of the spray nozzles is plural, the size of each of the spray nozzles is different.

9. The apparatus of claim 1, wherein when the number of the spray nozzles is plural, the size of each of the spray nozzles is the same.

10. The apparatus of claim 1, further comprising a heating needle covering the outer needle for spraying hot gas to enhance coagulating the fibers.

11. A spray nozzle, comprising:
an inner needle for spraying raw materials; and
an outer needle covering the inner needle for spraying coagulating agents whereby the raw materials sprayed by the inner needle interact with the coagulating agents sprayed by the outer needle to form a fiber.

12. The spray nozzle of claim 11, wherein the outer needle has an internal diameter substantially between 0.05 mm to 1 mm.

13. The spray nozzle of claim 11, wherein the inner needle has an internal diameter substantially between 0.05 mm to 1 mm.

14. The spray nozzle of claim 11, wherein the coagulating agents sprayed by the outer needle are vaporous.

15. The spray nozzle of claim 14, wherein the coagulating agents sprayed by the outer needle are pressed out of the outer needle.

16. The spray nozzle of claim 11, wherein the coagulating agents sprayed by the outer needle are liquid.

17. The spray nozzle of claim 11, wherein the spray nozzle has a distance between the top of the inner needle and the top of the outer needle, and the distance is adjustable.

18. The spray nozzle of claim 11, wherein the top of the inner needle is higher than the top of the outer needle.

19. The spray nozzle of claim 11, wherein the top of the inner needle is lower than the top of the outer needle.

20. The spray nozzle of claim 11, further comprising a heating needle covering the outer needle for spraying hot gas to enhance coagulating the fiber.
